(19) United States
(12) Patent Application Publication
(10) Pub. No.: US 2005/0144613 A1
(43) Pub. Date: Jun. 30, 2005

(54) Update firmware method and apparatus

(76) Inventor: Wei-Sheng Tseng, Hsichih (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/963,148

(22) Filed: Oct. 12, 2004

(30) Foreign Application Priority Data
Dec. 15, 2003 (TW) 92135342

(51) Int. Cl. G06F 9/44

(52) U.S. Cl. 717/168

(57) ABSTRACT

A method and apparatus for updating firmware providing a control chip, a first firmware stored in a storage medium, and a second firmware of the control chip. The connections between the control chip and an operating system are then interrupted. Next, write protection of the first and the second firmware is disabled. The second firmware is updated and the write protection of the first and second firmware is re-enabled.

### BACKGROUND

The present invention relates to data update, and in particular to a method and apparatus for update firmware of a keyboard controller (KBC).

Generally, keyboard controllers are designed as multi-function control chips, further comprising control functions such as temperature monitor, fan status, monitor brightness adjustment, and the like, except a keyboard control function. In desktop computers, firmware applied to a keyboard controller and Basic Input/Output System (BIOS) are stored separately in different storage media.

The described firmware is stored in a storage medium to reduce costs. Firmware update of a keyboard controller is secure in a conventional operating system, such as Disk Operating System (DOS), which is a single-tasking operating system, however, a system or BIOS crash may occur in a Windows Operating System, which is a multi-tasking operating system, without a proper updating method. Thus, an improved update method is desirable.

### SUMMARY

Embodiments of the invention provide an update firmware method, avoiding system or BIOS crashes during the firmware update process.

Accordingly, embodiments of the invention provide an update firmware method. First, a control chip, first firmware, and second firmware of the control chip are provided, both the first and second firmware are stored in a storage medium. Connections between the control chip and an operating system are interrupted. Next, write protection of the first and second firmware is disabled. The second firmware is updated and the write protection of the first and second firmware is re-enabled.

Embodiments of the invention further provide an update firmware apparatus. The apparatus comprises a first control chip managing all peripherals of a computer device, a second control chip managing a number of the peripherals of the computer device, and a storage medium storing first firmware and second firmware applied to the second control chip. Connections between the second control chip and an operating system are interrupted by the first firmware and write protection of the first and second firmware is then disabled. The second firmware is updated and the write protection of the first and second firmware is re-enabled.

A detailed description is given in the following embodiments with reference to the accompanying drawings.

### BRIEF DESCRIPTION OF THE DRAWINGS

Embodiments of the invention can be more fully understood by reading the subsequent detailed description and examples with references made to the accompanying drawings, wherein:

FIG. 1 is a schematic diagram of pins of a peripheral control chip and a storage medium according to an embodiment of the invention;

FIG. 2 is a schematic diagram of the architecture of the update firmware apparatus according to an embodiment of the invention; and

FIG. 3 is a flowchart of the update firmware method according to an embodiment of the invention.

### DETAILED DESCRIPTION

Embodiments of the invention disclose a method and apparatus for updating firmware.

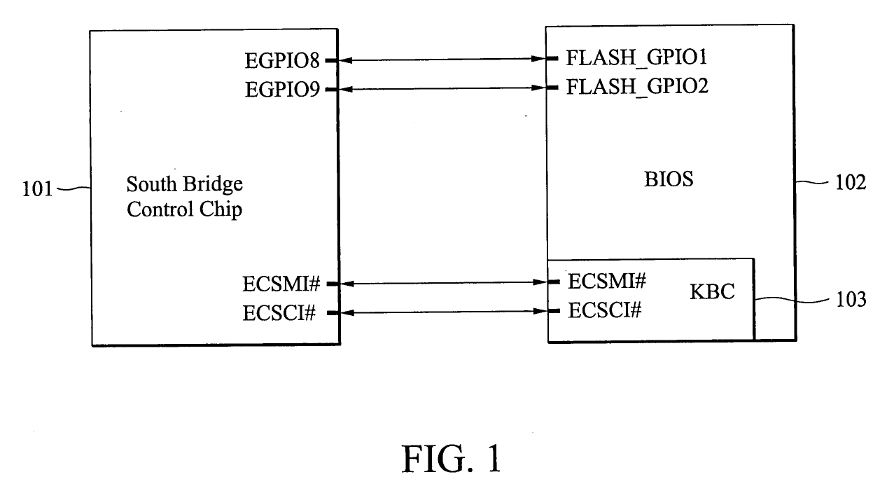

FIG. 1 is a schematic ping diagram of a peripheral control chip and a storage medium according to an embodiment of the invention.

A peripheral control chip 101 is a South Bridge control chip, comprising EGPIO8, EGPIO9, ECSMI#, and ECSCI# pins, # indicates the pins thereof are enabled at low level. A storage medium 102 is an Electronically Erasable Programmable Read-Only Memory (EEPROM), comprising FLASH_GPIO1 and FLASH_GPIO2 pins and ECSMI# and ECSCI# pins of KBC 103. EGPI08, EGPI09, ECSMI#, and ECSCI# pin of the peripheral control chip 101 connect respectively to FLASH_CPIO1 and FLASH_CPIO2 pin of the storage medium 102 and ECSMI# and ECSCI# pin of the KBC 103. Initially, the EGPIO8, EGPIO9, FLASH_GPIO1, and FLASH_GPIO2 pins are enabled at low level, enabling write protection of the BIOS.

Before a firmware update, a number of BIOS-level and OS-level routines are interrupted using the ECSMI# and ECSCI# pins of KBC 103, and levels of the EGPIO8, EGPIO9, FLASH_GPIO1, and FLASH_GPIO2 pins then change to high to disable the BIOS write protection.

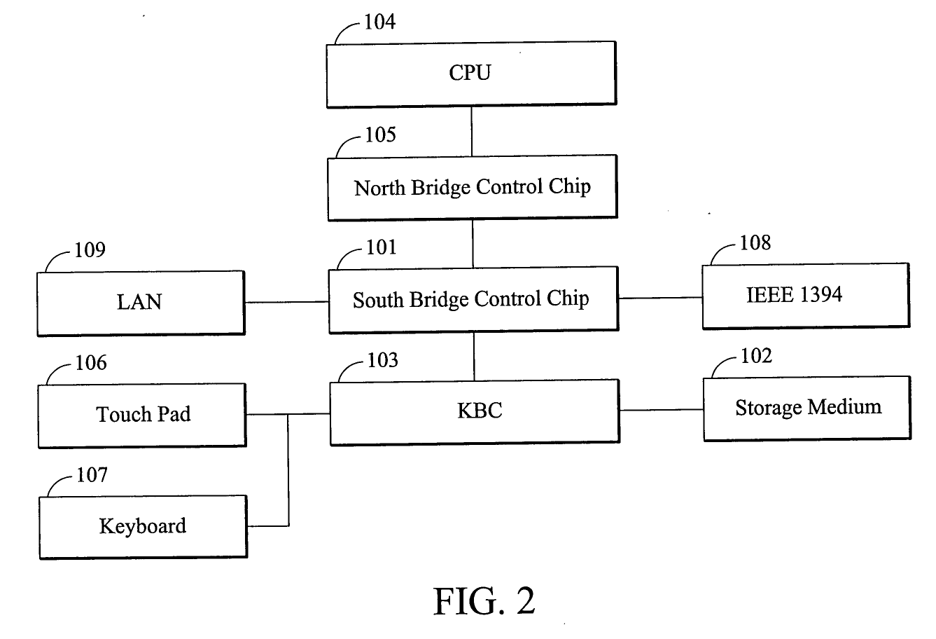

FIG. 2 is a schematic diagram of the architecture of the update firmware apparatus according to an embodiment of the invention.

The architecture at least comprises one South Bridge control chip 101, a storage medium 102, and a KBC 103. South Bridge control chip 101 manages peripherals, such as a high-speed serial bus (IEEE 1394) 108 and Local Area Network 109, of a computer device. KBC 103 manages a Touch Pad 106 and keyboard 107.

When the firmware update begins, the central processing unit (CPU) 104 sends a control command to a North Bridge control chip 105 for firmware update. North Bridge control chip 105 forwards the control command to South Bridge control chip 101 and BIOS stored in storage medium 102 interrupts connections between KBC 103 and an operating system of the computer device. In addition, a number of BIOS-level and OS-level routines are interrupted. Thereafter, the BIOS sends a control command to disable write protection of the KBC firmware, and levels of the EGPIO8, EGPIO9, FLASH_GPIO1, and FLASH_GPIO2 pins then change to high to disable the write protection of the BIOS.

Next, the KBC firmware, stored in storage medium 102, is updated and then re-enabled by a control command from the BIOS to re-enable the write protection of the KBC firmware. Thereafter, the levels of the EGPIO8, EGPIO9, FLASH_GPIO1, and FLASH_GPIO2 pins then change to low to re-enable the BIOS write protection.

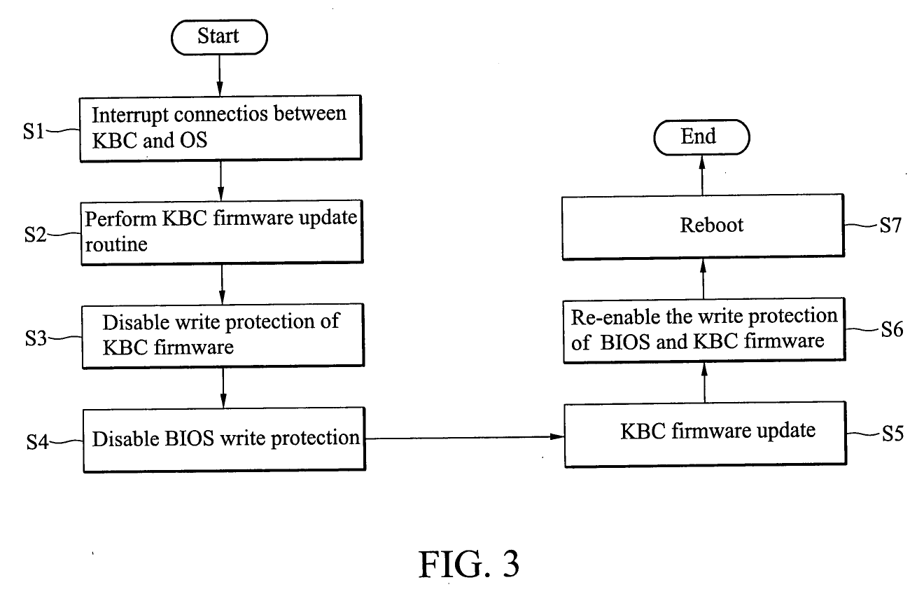

FIG. 3 is a flowchart of the update firmware method according to an embodiment of the invention.

In step S1, connections between KBC firmware and an operating system are interrupted, indicating read and write of input/output (I/O) ports of the control chip, a keyboard, and a mouse. A number of BIOS-level and OS-level routines must be interrupted, leaving the others that are irrelevant to the firmware update unchanged.

In step S2, BIOS sends a system call KBC firmware to perform an update routine thereof.

In step S3, write protection of the KBC firmware is disabled by a control command.

In step S4, write protection of the BIOS is disabled. Two specific pins of a peripheral control chip couple to two specific pins of a storage medium. Initially, the pins are enabled at low level, enabling the write protection of the BIOS. Levels of the pins herein change to high to disable the BIOS write protection.

In step S5, the KBC firmware stored in the storage medium is updated.

In step S6, after firmware update, the write protection of the KBC firmware is re-enabled by a control command, and the levels of the pins change to low to re-enabled the BIOS write protection.

In step S7, the operating system reboots to activate the KBC firmware.

Embodiments of the invention provide a method for updating KBC firmware in a multi-tasking operating system, capable of preventing system or BIOS crashes.

While the invention has been described by way of example and in terms of preferred embodiment, it is to be understood that the invention is not limited thereto.

1. A method for updating firmware, comprising:
providing a control chip, a first firmware stored in a storage medium, and a second firmware of the control chip,
interrupting connections between the control chip and an operating system;
disabling write protection of the first and the second firmware;
updating the second firmware; and
enabling the write protection of the first and second firmware.

2. The method as claimed in claim 1, wherein before disabling the write protection, the first firmware sends a system call to the second firmware to perform an update routine thereof.

3. The method as claimed in claim 1, wherein the connections indicate read and write of input/output (I/O) ports of the control chip, a keyboard, and a mouse.

4. The method as claimed in claim 3, wherein during connection interrupt, connection states between the operating system and the control chip, keyboard, and mouse, are determined by hardware addresses of the I/O ports.

5. The method as claimed in claim 1, wherein during connection interrupt, a number of BIOS-level and OS-level routines are interrupted by the operating system.

6. The method as claimed in claim 1, wherein the operating system reboots after the firmware update is complete.

7. The method as claimed in claim 1, wherein the first firmware is BIOS.

8. The method as claimed in claim 1, wherein the control chip is a keyboard controller.

9. The method as claimed in claim 8, wherein the second firmware is applied to the keyboard controller.

10. An apparatus for updating firmware, comprising:
a first control chip, managing peripherals of a computer device;
a second control chip, coupled to the first control chip, managing a number of the peripherals of the computer device; and
a storage medium, coupled to the first and second control chips, storing first firmware and second firmware of the second control chip,
wherein connections between the second control chip and an operating system are interrupted by the first firmware, write protection of the first and second firmware is disabled, the second firmware is updated, and the write protection of the first and second firmware is enabled.

11. The apparatus as claimed in claim 10, wherein the first control chip further comprises a first and a second pins, the second control chip further comprises a third and a fourth pins, wherein the first pin couples to the third pin and the second pin couples to the fourth pin.

12. The apparatus as claimed in claim 10, wherein the first firmware sends a system call to the second firmware to perform an update routine thereof before the write protection of the first and second firmware is disabled.

13. The apparatus as claimed in claim 10, wherein the connection between the second controller chip and the operating system includes the second controller chip, a keyboard, and a read and write of I/O ports of a mouse.

14. The apparatus as claimed in claim 13, wherein connection states between the operating system and the second control chip, keyboard, and mouse, are determined by hardware addresses of the I/O ports.

15. The apparatus as claimed in claim 10, wherein a command interrupts a number of BIOS-level and OS-level routines.

16. The apparatus as claimed in claim 10, wherein the operating system reboots after the firmware update is complete.

17. The apparatus as claimed in claim 1, wherein the first control chip is a South Bridge control chip.

18. The apparatus as claimed in claim 10, wherein the first firmware is BIOS.

19. The apparatus as claimed in claim 10, wherein the second control chip is a keyboard controller.

20. The apparatus as claimed in claim 19, wherein the second firmware is applied to the keyboard controller.
